(19) United States
(12) Patent Application Publication
(10) Pub. No.: US 2024/0320492 A1
(43) Pub. Date: Sep. 26, 2024

(54) PRESERVATION OF DEEP LEARNING CLASSIFIER CONFIDENCE DISTRIBUTIONS

(71) Applicant: International Business Machines Corporation, Armonk, NY (US)

(72) Inventors: Tong Liu, Shanxi (CN); Li Juan Gao, Xi'an (CN); Zhong Fang Yuan, Xi'an (CN); Yu Zui You, Ningbo (CN); Xiang Yu Yang, Xi'an (CN)

(21) Appl. No.: 18/187,436

(22) Filed: Mar. 21, 2023

(51) Int. Cl. G06N 3/084

(52) U.S. Cl. CPC G06N 3/084

(57) ABSTRACT

Systems and techniques that facilitate preservation of deep learning classifier confidence distributions are provided. In various embodiments, a system can access a deep learning classifier and a training dataset on which the deep learning classifier was trained. In various aspects, the system can re-train the deep learning classifier using a loss function that is based on a Gaussian mixture model constructed from the training dataset.

### BACKGROUND

The subject disclosure relates to deep learning classifiers, and more specifically to preservation of deep learning classifier confidence distributions.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate preservation of deep learning classifier confidence distributions are described.

According to one or more embodiments, a system is provided. In various aspects, the system can comprise a processor that can execute computer-executable components stored in a non-transitory computer-readable memory. In various instances, the computer-executable components can comprise an access component that can access a deep learning classifier and a training dataset on which the deep learning classifier was trained. In various cases, the computer-executable components can comprise a re-training component that can re-train the deep learning classifier using a loss function that is based on a Gaussian mixture model constructed from the training dataset.

According to various embodiments, the above-described system can be implemented as a computer-implemented method or as a computer program product.

### DESCRIPTION OF THE DRAWINGS

FIG. 1 illustrates a block diagram of an example, non-limiting system that facilitates preservation of deep learning classifier confidence distributions in accordance with one or more embodiments described herein.

FIG. 2 illustrates a block diagram of an example, non-limiting system including a class-collated confidence dataset that facilitates preservation of deep learning classifier confidence distributions in accordance with one or more embodiments described herein.

FIGS. 3-4 illustrate example, non-limiting block diagrams showing how a class-collated confidence dataset can be generated in accordance with one or more embodiments described herein.

FIG. 5 illustrates a block diagram of an example, non-limiting system including a Gaussian mixture model that facilitates preservation of deep learning classifier confidence distributions in accordance with one or more embodiments described herein.

FIG. 6 illustrates an example, non-limiting block diagram showing how a Gaussian mixture model can be generated based on a class-collated confidence dataset in accordance with one or more embodiments described herein.

FIG. 7 illustrates a block diagram of an example, non-limiting system including a loss function that facilitates preservation of deep learning classifier confidence distributions in accordance with one or more embodiments described herein.

FIG. 8 illustrates an example, non-limiting block diagram showing how a deep learning classifier can be re-trained based on a Gaussian mixture model in accordance with one or more embodiments described herein.

FIGS. 9-11 illustrate flow diagrams of example, non-limiting computer-implemented methods that facilitate preservation of deep learning classifier confidence distributions in accordance with one or more embodiments described herein.

FIG. 12 illustrates a flow diagram of an example, non-limiting computer-implemented method that facilitates preservation of deep learning classifier confidence distributions in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A deep learning classifier can be any suitable neural network that can be configured to receive as input any suitable data (e.g., image data, audio data, textual data, timeseries data, or any suitable combination thereof) and to produce as output a classification label for that inputted data. That is, the deep learning classifier can be configured to predict or infer to which one of two or more possible classes the inputted data belongs.

In various aspects, it can be the case that the deep learning classifier produces as output not only the classification label, but also a confidence score corresponding to the classification label. In various instances, the confidence score can be a real-valued scalar ranging from 0 to 1 representing a probability or likelihood that the classification label (e.g., that the prediction or inference produced by the deep learning classifier) is correct or accurate for the inputted data.

In various cases, such confidence score can be compared to a threshold value for deciding whether or not additional processing of the inputted data is warranted. For example, if the confidence score satisfies (e.g., is greater than or equal to) the threshold value, it can be concluded that additional processing of the inputted data is not warranted. On the other hand, if the confidence score instead fails to satisfy (e.g., is less than) the threshold value, then it can be concluded that additional processing (e.g., manual review of the inputted data by a subject matter expert, execution of an ensemble of other deep learning classifiers on the inputted data for classification voting or ranking) is warranted.

The magnitude of the threshold value can be heavily dependent upon the deep learning classifier and its operational context (e.g., on whether the deep learning classifier is implemented or deployed in a high-stakes field where classification accuracy is critical, such as medical diagnostics, or instead in a low-stakes field where classification accuracy is less critical, such as keyword searching). In particular, it can be initially unknown what magnitude of the threshold value would yield sufficiently acceptable or desirable classification outcomes in practice. For example, if the magnitude of the threshold value is set too low given the operational context, then the deep learning classifier can be considered as being over-trusted, and manual review or ensemble voting in such cases can be considered as being underutilized. This can yield insufficiently accurate classification results. In contrast, if the magnitude of the threshold value is set too high given the operational context, then the deep learning classifier can instead be considered as being under-trusted, and manual review or ensemble voting can in such cases be considered as being overutilized. This can cause excessive consumption of time or computing resources.

Experimental trial-and-error can be, and often is, implemented to identify at which magnitude the threshold value should be set. In other words, such experimentation can be used to identify a magnitude at which the threshold value is neither too high nor too low for the operational context of the deep learning classifier.

It can be desired to periodically re-train the deep learning classifier over time. Such re-training can allow the deep learning classifier to learn how to handle (e.g., how to properly classify) new data (e.g., data that the deep learning classifier had not encountered previously). In other words, such re-training can help the deep learning classifier to remain current, relevant, or otherwise up-to-date.

Unfortunately, when re-training is performed according to existing techniques, such re-training can render whatever magnitude had been experimentally selected or identified for the threshold value as obsolete. In other words, after re-training according to existing techniques, that experimentally selected or identified magnitude can now be considered as being too high or too low for the deep learning classifier. Thus, when existing techniques are used to re-train the deep learning classifier, a new magnitude for the threshold value can be experimentally obtained. Such experimentation can be performed each time the deep learning classifier is re-trained according to existing techniques. Such repeated experimentation can be considered as excessively costly in terms of time and resources, which can be undesirable or disadvantageous.

Accordingly, systems or techniques that can address one or more of these technical problems can be desired.

Various embodiments described herein can address one or more of these technical problems. Specifically, various embodiments described herein can facilitate preservation of deep learning classifier confidence distributions. That is, the inventors of various embodiments described herein realized why existing techniques for re-training a deep learning classifier can render an experimentally determined confidence score threshold value for that deep learning classifier obsolete, and the present inventors accordingly devised various techniques for ameliorating or preventing such obsolescence.

In particular, the present inventors recognized that the trainable internal parameters (e.g., weight matrices, bias values, convolutional kernels) of a deep learning classifier can be considered as numerically representing or capturing the feature distributions of whatever data on which the deep learning classifier is trained. Thus, when the deep learning classifier is trained on original data, its trainable internal parameters can be considered as representing or capturing the feature distributions present in that original data. Similarly, when the deep learning classifier is re-trained on new data, its trainable internal parameters can be considered as now representing or capturing, at least partially, the feature distributions present in that new data. If the feature distributions of that new data differ substantially from those of the original data, the deep learning classifier can exhibit significantly different prediction or inferencing behavior after re-training.

Using this insight, the present inventors realized that existing techniques for facilitating re-training cause confidence score threshold value obsolescence at least in part because such existing techniques do not constrain the outputted confidence scores of the deep learning classifier during re-training. More specifically, the present inventors realized that such obsolescence can be reduced or eliminated by forcing the deep learning classifier's outputted confidence scores during re-training to follow whatever distributions those confidence scores exhibited during original training. As described herein, this can be accomplished by constructing a Gaussian mixture model using the data on which the deep learning classifier was originally trained. In particular, such Gaussian mixture model can be considered as defining the label-collated distributions of confidence scores outputted by the deep learning classifier during original training. In various cases, when re-training is performed on the deep learning classifier, whatever re-training loss function is used can be based on such Gaussian mixture model. Such re-training loss function can thus be considered as forcing the deep learning classifier to learn how to output confidence scores for new data, where such confidence scores follow the original confidence score distributions. When re-trained in such fashion, whatever confidence score threshold value was previously experimentally obtained can be considered as still relevant or otherwise not obsolete. Thus, when various embodiments described herein are implemented, a new confidence score threshold value need not be experimentally obtained each time the deep learning classifier is re-trained.

Various embodiments described herein can be considered as a computerized tool (e.g., any suitable combination of computer-executable hardware or computer-executable software) that can facilitate preservation of deep learning classifier confidence distributions. In various aspects, such a computerized tool can comprise an access component, a data component, a Gaussian component, or a re-training component.

In various embodiments, there can be a deep learning classifier. In various aspects, the deep learning classifier can exhibit any suitable neural network architecture. For example, the deep learning classifier can include any suitable numbers of any suitable types of layers (e.g., input layer, one or more hidden layers, output layer, any of which can be convolutional layers, dense layers, non-linearity layers, pooling layers, batch normalization layers, or padding layers). As another example, the deep learning classifier can include any suitable numbers of neurons in various layers (e.g., different layers can have the same or different numbers of neurons as each other). As yet another example, the deep learning classifier can include any suitable activation functions (e.g., softmax, sigmoid, hyperbolic tangent, rectified linear unit) in various neurons (e.g., different neurons can have the same or different activation functions as each other). As still another example, the deep learning classifier can include any suitable interneuron connections or interlayer connections (e.g., forward connections, skip connections, recurrent connections).

Regardless of its internal architecture, the deep learning classifier can have been already trained (e.g., via supervised training, unsupervised training, or reinforcement learning) to classify a data candidate. In various aspects, the data candidate can be any suitable electronic data exhibiting any suitable format, size, or dimensionality (e.g., the data candidate can be any suitable number of scalars, vectors, matrices, tensors, or character strings). As some non-limiting examples, the data candidate can be image data, video data, audio data, textual data, timeseries data, or any suitable combination thereof.

In any case, the deep learning classifier can be configured to receive the data candidate as input and to produce as output both a classification label and a confidence score for that data candidate. In various instances, the classification label can be any suitable electronic data having any suitable format, size, or dimensionality that can indicate to which one of two or more possible classes the deep learning classifier predicts or infers that the data candidate belongs. As a non-limiting example, the classification label can be a discretely-varying, integer-valued scalar having two or more possible values, where such two or more possible values respectively correspond (e.g., in one-to-one fashion) to the two or more possible classes. In various cases, the confidence score can be a real-valued scalar continuously-varying (or, in some cases, discretely-varying) between 0 and 1 and representing a likelihood that the classification label is correct or accurate with respect to the data candidate.

In various aspects, there can be a training dataset. In various instances, the training dataset can comprise a set of training data candidates. In various cases, a training data candidate can be any suitable data candidate which the deep learning classifier previously encountered during training (e.g., on which the deep learning classifier has already been trained). In various aspects, the deep learning classifier can have undergone any suitable style, type, or paradigm of training with respect to the training dataset. As some non-limiting examples, the deep learning classifier can have undergone supervised training on the training dataset (e.g., in such case, each training data candidate can be considered as being annotated), unsupervised training on the training dataset (e.g., in such case, each training data candidate can be considered as being unannotated), or reinforcement learning on the training dataset.

In various aspects, there can be a new training data candidate. In various instances, the new training data candidate can be any suitable data candidate which the deep learning classifier has not yet encountered during training (e.g., on which the deep learning classifier has not yet been trained). In various cases, it can be desired to re-train the deep learning classifier on the new training data candidate, while preserving whatever confidence score distributions are currently exhibited by the deep learning classifier. As described herein, the computerized tool can facilitate such re-training.

In various aspects, the access component of the computerized tool can electronically receive or otherwise access the deep learning classifier, the training dataset, or the new training data candidate. For example, the access component can retrieve the deep learning classifier, the training dataset, or the new training data candidate from any suitable centralized or decentralized data structure (e.g., graph data structure, relational data structure, hybrid data structure), whether remote from or local to the access component. In any case, the access component can obtain or access the deep learning classifier, the training dataset, or the new training data candidate, such that other components of the computerized tool can electronically interact with (e.g., initiate, execute, control, read, write, edit, copy, manipulate) the deep learning classifier, the training dataset, or the new training data candidate.

In various aspects, the data component of the computerized tool can electronically generate a set of confidence score lists collated according to class, based on the training dataset. In particular, the data component can execute the deep learning classifier on each of the set of training data candidates in the training dataset. Such executions can yield a set of classification labels and a set of confidence scores, both of such sets respectively corresponding (e.g., in one-to-one fashion) with the set of training data candidates. More specifically, for any given training data candidate, the data component can feed that given training data candidate to an input layer of the deep learning classifier, that given training data candidate can complete a forward pass through one or more hidden layers of the deep learning classifier, and an output layer of the deep learning classifier can compute a classification label and a confidence score based on activations from the one or more hidden layers. In other words, the deep learning classifier can predict or infer for each training data candidate in the training dataset a label-confidence tuple. Now, there can be more training data candidates in the training dataset than there are possible or unique classes which the deep learning classifier can identify as output. Thus, some of the set of classification labels produced by the deep learning classifier can indicate the same class as each other. Because each of the set of classification labels can correspond to a respective one of the set of confidence scores, and because various of the set of classification labels can indicate the same possible or unique class as each other, there can be multiple confidence scores per possible or unique class. In other words, there can be a list of confidence scores corresponding to each possible or unique class. When considered collectively over all the possible or unique classes, such lists can be considered as forming the set of confidence score lists collated according to class.

In various aspects, the Gaussian component of the computerized tool can electronically generate a Gaussian mixture model, based on the set of confidence score lists. In particular, a Gaussian mixture model can be considered as a probabilistic model that assumes that a collection of data is a mixture of a finite number of constituent Gaussian distributions (e.g., of bell curves), with each constituent Gaussian distribution having initially unknown parameters (e.g., having initially unknown means, variances, and standard deviations). Those initially unknown parameters can be iteratively estimated via any suitable optimization algorithms, such as expectation maximization or stochastic gradient descent. In some cases, a Gaussian mixture model can be implemented in unsupervised fashion (e.g., so as to cluster unlabeled data). However, in other cases, a Gaussian mixture model can be implemented in supervised fashion (e.g., so as to cluster already-labeled data). In various aspects, the set of confidence score lists can be considered as already-labeled data (e.g., each list of confidence scores can be considered as corresponding to, or being labeled by, one of the possible or unique classes). Accordingly, in various instances, the Gaussian component can electronically fit, in supervised fashion, a Gaussian mixture model to the set of confidence score lists, where the total number of constituent Gaussian distributions can be equal to the total number of possible or unique classes. In other words, for any given possible or unique class, the Gaussian mixture model can comprise a unique constituent Gaussian for that given possible or unique class, where the parameters (e.g., mean, variance, standard deviation) for that unique constituent Gaussian can have been iteratively learned in supervised fashion from whichever list of confidence scores correspond to that given possible or unique class. Thus, each constituent Gaussian of the Gaussian mixture model can be considered as describing or otherwise representing how the confidence scores of a respective possible or unique class were originally distributed by the deep learning classifier.

In various aspects, the re-training component of the computerized tool can electronically re-train the deep learning classifier on the new training data candidate, by leveraging the Gaussian mixture model. In particular, the re-training component can re-train the deep learning classifier with a loss function, where such loss function can be based on the Gaussian mixture model.

More specifically, the re-training component can electronically execute the deep learning classifier on the new training data candidate, which can cause the deep learning classifier to produce a particular classification label and a particular confidence score for the new training data candidate. That is, the re-training component can feed the new training data candidate to the input layer of the deep learning classifier, the new training data candidate can complete a forward pass through the one or more hidden layers of the deep learning classifier, and the output layer of the deep learning classifier can compute the particular classification label and the particular confidence score based on activations from the one or more hidden layers. In this way, the deep learning classifier can predict or infer a label-confidence tuple for the new training data candidate.

In various aspects, the re-training component can compute a first numerical term of the loss function based on the particular classification label. For example, if the new training data candidate is annotated, then the re-training component can compute as the first numerical term an error (e.g., mean absolute error (MAE), mean squared error (MSE), cross-entropy error) between the particular classification label and a ground-truth classification label that is known or deemed to correspond to the new training data candidate. As another example, if the new training data candidate is instead unannotated, then the re-training component can compute as the first numerical term any suitable unsupervised error based on the particular classification label. In any case, the first numerical term of the loss function can be considered as depending upon the particular classification label that the deep learning classifier has predicted or inferred for the new training data candidate.

In various instances, the re-training component can compute a second numerical term of the loss function based on the Gaussian mixture model. Indeed, in various cases, the re-training component can identify which constituent Gaussian of the Gaussian mixture model corresponds to the particular classification label produced by the deep learning classifier. In other words, the particular classification label can indicate one of the possible or unique classes, and the re-training component can identify which constituent Gaussian corresponds to that possible or unique class. In various aspects, the re-training component can compute a measure of fit between the particular confidence score and that identified constituent Gaussian. In various instances, the measure of fit can be any suitable real-valued scalar that can indicate or otherwise represent how well or how poorly the particular confidence score fits into the identified constituent Gaussian. In some cases, the measure of fit can be equal to otherwise based on an integration degree computed between the particular confidence score and the identified constituent Gaussian. However, this is a mere non-limiting example. In other cases, the measure of fit can instead be based on distance (e.g., in terms of number of standard deviations) between the particular confidence score and a mean of the identified constituent Gaussian. In any case, the re-training component can compute the second numerical term based on the measure of fit, such that the second numerical term increases as the measure of fit becomes worse (e.g., indicates worse fit), and such that the second numerical term decreases as the measure of fit becomes better (e.g., indicates better fit).

In various aspects, the loss function can be any suitable additive, multiplicative, exponential, or other combination of the first numerical term and the second numerical term. In various instances, the re-training component can incrementally update, via backpropagation (e.g., stochastic gradient descent), the trainable internal parameters (e.g., weight matrices, bias values, convolutional kernels) of the deep learning classifier, where such backpropagation can be driven by the loss function. In various cases, such execution and update procedure can be repeated for any suitable number of new training data candidates. Indeed, note that any suitable re-training batch sizes or any suitable re-training termination criterion can be implemented by the re-training component.

In any case, the first numerical term in the loss function can be considered as causing the deep learning classifier to learn how to accurately or correctly classify new data candidates. Moreover, the second numerical term in the loss function can be considered as causing the deep learning classifier to produce confidence scores for such new data candidates according to the distributions represented by the Gaussian mixture model. In other words, the second numerical term can be considered as causing the deep learning classifier to output confidence scores according to the distributions that the deep learning classifier was originally trained to exhibit. In still other words, the second numerical term can be considered as causing the deep learning classifier to preserve the confidence score distributions that it was originally trained to have. Thus, a confidence score threshold value that has been experimentally determined for the deep learning classifier need not be experimentally re-determined after re-training.

Various embodiments described herein can be employed to use hardware or software to solve problems that are highly technical in nature (e.g., to facilitate preservation of deep learning classifier confidence distributions), that are not abstract and that cannot be performed as a set of mental acts by a human. Further, some of the processes performed can be performed by a specialized computer (e.g., deep learning classifier). In various aspects, some defined tasks associated with various embodiments described herein can include: accessing, by a device operatively coupled to a processor, a deep learning classifier and a training dataset on which the deep learning classifier was trained; and re-training, by the device, the deep learning classifier using a loss function that is based on a Gaussian mixture model constructed from the training dataset.

Neither the human mind nor a human with pen and paper can electronically access both a deep learning classifier and original training data on which the deep learning classifier was trained and electronically re-train the deep learning classifier by leveraging a Gaussian mixture model built from such original training data. After all, a deep learning classifier is an artificial neural network that has specific internal parameters (e.g., convolutional kernels, weight matrices, bias values). An artificial neural network is an inherently computerized construct that cannot meaningfully be implemented by the human mind or by a human with pen and paper. Moreover, the process of training an artificial neural network is an inherently computerized procedure that can involve iteratively feeding the artificial neural network with training data and incrementally updating its internal parameters via an optimization technique, such as stochastic gradient descent. Neither the human mind, nor a human with pen and paper, can meaningfully perform such a training procedure on an artificial neural network. Therefore, a computerized tool that can perform training on a deep learning classifier is inherently computerized and cannot be implemented in any sensible, practicable, or reasonable way without computers.

In various instances, one or more embodiments described herein can integrate the herein-described teachings into a practical application. As mentioned above, a deep learning classifier can be configured to output not just classification labels but also confidence scores. Whether or not to perform post-processing (e.g., such as manual review or ensemble voting/ranking) for a given data candidate can depend upon whether or not a confidence score produced by the deep learning classifier for that given data candidate satisfies a threshold value. If the threshold value is set too high, the deep learning classifier can be considered as being under-trusted, and post-processing can be considered as being over-used. In contrast, if the threshold value is set too low, the deep learning classifier can be considered as being over-trusted, and post-processing can be considered as being under-used. Experimentation is often implemented to identify at what magnitude the threshold value should be set. Unfortunately, when existing techniques are implemented to re-train the deep learning classifier, that experimentally-identified magnitude for the threshold value can become obsolete. Thus, whenever the deep learning classifier is re-trained according to existing techniques, costly or time-consuming experimentation can be warranted to identify at what new magnitude the threshold value should be set. This can result in excessive accumulation of time or other resources spent on experimentation, which can be undesirable or disadvantageous.

Various embodiments described herein can address one or more of these technical problems. In particular, the present inventors realized that existing techniques for re-training the deep learning classifier render an experimentally-identified magnitude of the threshold value obsolete at least in part because such existing techniques fail to constrain the confidence scores outputted by the deep learning classifier. More specifically, the present inventors recognized that, upon being trained, the deep learning classifier can be considered as having learned to produce confidence scores according to various distributions. The present inventors further recognized that, upon being re-trained by existing techniques, the deep learning classifier can be considered as having learned to produce confidence scores according to different distributions. Thus, the present inventors devised various embodiments described herein, which can be considered as causing or otherwise forcing the deep learning classifier to preserve its original confidence score distributions during re-training. In various aspects, such embodiments can involve: generating, based on whatever data on which the deep learning classifier was originally trained, a set of confidence score lists collated by class; fitting a supervised Gaussian mixture model to the set of confidence score lists, where the supervised Gaussian mixture model can be considered as quantitatively defining or representing the original confidence score distributions of the deep learning classifier; and re-training the deep learning classifier using a loss-function that takes the supervised Gaussian mixture model into account. By taking the supervised Gaussian mixture model into account, the deep learning classifier can be re-trained while also preserving its original confidence score distributions. In other words, the supervised Gaussian mixture model can be considered or otherwise treated as an adversarial discriminator that can help to force the deep learning classifier to learn how to correctly classify new data candidates without significantly changing the distributions according to which it produces confidence scores. In still other words, the supervised Gaussian mixture model can be considered as preventing re-training from destabilizing the original confidence score distributions of the deep learning classifier. Because the deep learning classifier can be re-trained by various embodiments described herein without suffering significant change in confidence score distributions, any experimentally-identified magnitude of the threshold value can be considered as not having been rendered obsolete by such re-training. Thus, follow-on experimentation for re-determining the threshold value can be reduced or otherwise eliminated, in stark contrast to various existing techniques. This is a concrete and tangible technical improvement in the field of deep learning classifiers. For at least these reasons, various embodiments described herein certainly constitute useful and practical applications of computers.

It should be appreciated that the figures and the herein disclosure describe non-limiting examples of various embodiments. It should further be appreciated that the figures are not necessarily drawn to scale.

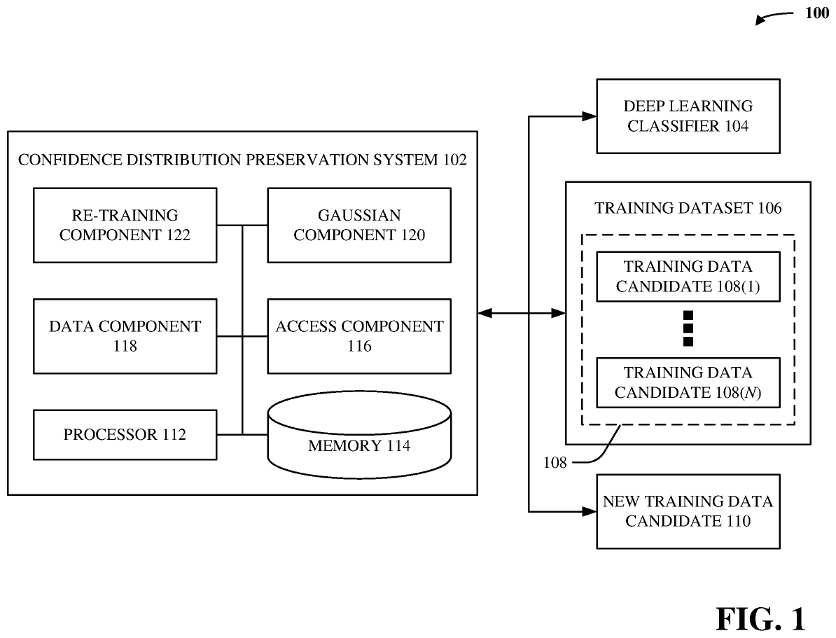

FIG. 1 illustrates a block diagram of an example, non-limiting system 100 that can facilitate preservation of deep learning classifier confidence distributions in accordance with one or more embodiments described herein. As shown, a confidence distribution preservation system 102 can be electronically integrated, via any suitable wired or wireless electronic connections, with a deep learning classifier 104, with a training dataset 106, or with a new training data candidate 110.

In various embodiments, the deep learning classifier 104 can have or otherwise exhibit any suitable internal neural network architecture. For instance, the deep learning classifier 104 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In various aspects, the deep learning classifier 104 can be configured to receive as input a data candidate and to produce as output a classification label and a confidence score for that data candidate.

In various instances, a data candidate can be any suitable type of electronic data exhibiting any suitable format, size, or dimensionality. In other words, a data candidate can be one or more scalars, one or more vectors, one or more matrices, one or more tensors, one or more character strings, or any suitable combination thereof. As a non-limiting example, a data candidate can be one or more two-dimensional pixel arrays. As another non-limiting example, a data candidate can be one or more three-dimensional voxel arrays. As still another non-limiting example, a data candidate can be one or more time-indexed audio files. As yet another non-limiting example, a data candidate can be one or more textual sentences or sentence fragments. As even another non-limiting example, a data candidate can be one or more waveform spectra. As another non-limiting example, a data candidate can be any suitable combination of the aforementioned.

In various cases, a classification label can be any suitable electronic data exhibiting any suitable format, size, or dimensionality that can indicate or otherwise represent one of m defined classes, for any suitable positive integer m≥2. As a non-limiting example, a classification label can be an integer-valued scalar whose magnitude can range from 1 to m, inclusively. Thus, the magnitude of the classification label can be considered as an index indicating a specific one of the m defined classes.

In various aspects, a confidence score can be any suitable electronic data exhibiting any suitable format, size, or dimensionality that can indicate or otherwise represent a probability or likelihood that a respective classification label is correct or accurate. As a non-limiting example, a confidence score can be a real-valued scalar whose magnitude can range from 0 to 1, inclusively. Thus, the magnitude of the confidence score can be considered as a probability of correctness for a corresponding classification label.

Accordingly, the deep learning classifier 104 can be configured to classify an inputted data candidate into one of m defined classes, and the deep learning classifier 104 can further be configured to indicate a level of confidence (e.g., a probability or likelihood of correctness) for such classification.

In various aspects, the deep learning classifier 104 can have previously undergone any suitable type or paradigm of training. As a non-limiting example, the deep learning classifier 104 can have previously undergone supervised training to learn how to accurately classify inputted data candidates. As another non-limiting example, the deep learning classifier 104 can have previously undergone unsupervised training to learn how to accurately classify inputted data candidates. As yet another non-limiting example, the deep learning classifier 104 can have previously undergone reinforcement learning to learn how to accurately classify inputted data candidates.

In various instances, the training dataset 106 can comprise a set of training data candidates 108. In various cases, the set of training data candidates 108 can comprise n data candidates for any suitable positive integer n>m: a training data candidate 108(1) to a training data candidate 108(n). In various aspects, each of the set of training data candidates 108 can be any suitable data candidate on which the deep learning classifier 104 was previously trained. As a non-limiting example, the training data candidate 108(1) can be a first data candidate that the deep learning classifier 104 encountered (e.g., was executed on) during training. As another non-limiting example, the training data candidate 108(n) can be an n-th data candidate that the deep learning classifier 104 encountered during training. In various instances, all of the set of training data candidates 108 can exhibit the same format, size, or dimensionality as each other.

In various cases, as mentioned above, the deep learning classifier 104 can have previously undergone supervised training. In such cases, each of the set of training data candidates 108 can be annotated. As a non-limiting example, the training data candidate 108(1) can correspond to a first ground-truth annotation (not shown), where the first ground-truth annotation can be a correct or accurate classification label that is known or deemed to correspond to the training data candidate 108(1). As another non-limiting example, the training data candidate 108(n) can correspond to an n-th ground-truth annotation (not shown), where the n-th ground-truth annotation can be a correct or accurate classification label that is known or deemed to correspond to the training data candidate 108(n). In various other cases, however, the deep learning classifier 104 can instead have undergone unsupervised training or reinforcement learning. In such cases, each of the set of training data candidates 108 can be unannotated (e.g., can lack ground-truth annotations).

In various aspects, after training on the training dataset 106, a confidence threshold value (not shown) can be experimentally obtained for the deep learning classifier 104. In various instances, for any given data candidate, the deep learning classifier 104 can generate a classification label and a confidence score for such given data candidate, and that confidence score can be compared with the confidence threshold value to determine whether or not post-processing (e.g., manual review, ensemble voting/ranking) of the given data candidate is warranted.

In various cases, the new training data candidate 110 can be any suitable data candidate on which the deep learning classifier 104 was not previously trained (e.g., can be any suitable data candidate which the deep learning classifier 104 did not previously encounter during training). In various aspects, the new training data candidate 110 can exhibit the same format, size, or dimensionality as each of the set of training data candidates 108.

In any case, it can be desired to re-train the deep learning classifier 104 on the new training data candidate 110. As explained above, if existing techniques were utilized to facilitate such re-training, the confidence threshold value that was experimentally obtained for the deep learning classifier 104 can become obsolete. Thus, it can be desired to re-train the deep learning classifier 104 without rendering such confidence threshold value obsolete. As explained herein, the confidence distribution preservation system 102 can facilitate such re-training.

In various embodiments, the confidence distribution preservation system 102 can comprise a processor 112 (e.g., computer processing unit, microprocessor) and a non-transitory computer-readable memory 114 that is operably connected or coupled to the processor 112. The memory 114 can store computer-executable instructions which, upon execution by the processor 112, can cause the processor 112 or other components of the confidence distribution preservation system 102 (e.g., access component 116, data component 118, Gaussian component 120, re-training component 122) to perform one or more acts. In various embodiments, the memory 114 can store computer-executable components (e.g., access component 116, data component 118, Gaussian component 120, re-training component 122), and the processor 112 can execute the computer-executable components.

In various embodiments, the confidence distribution preservation system 102 can comprise an access component 116. In various aspects, the access component 116 can electronically receive or otherwise electronically access the deep learning classifier 104, the training dataset 106, or the new training data candidate 110. As a non-limiting example, the access component 116 can electronically retrieve, obtain, or import, from any suitable data structures or from any suitable computing devices (not shown), the deep learning classifier 104, the training dataset 106, or the new training data candidate 110. In any case, the access component 116 can electronically access the deep learning classifier 104, the training dataset 106, or the new training data candidate 110, such that other components of the confidence distribution preservation system 102 can electronically interact with or otherwise electronically control the deep learning classifier 104, the training dataset 106, or the new training data candidate 110.

In various embodiments, the confidence distribution preservation system 102 can comprise a data component 118. In various aspects, as described herein, the data component 118 can electronically generate a class-collated confidence dataset based on the deep learning classifier 104 and based on the training dataset 106.

In various embodiments, the confidence distribution preservation system 102 can comprise a Gaussian component 120. In various instances, as described herein, the Gaussian component 120 can electronically generate a Gaussian mixture model, based on the class-collated confidence dataset.

In various embodiments, the confidence distribution preservation system 102 can comprise a re-training component 122. In various cases, as described herein, the re-training component 122 can electronically re-train the deep learning classifier 104 on the new training data candidate 110, where such re-training can involve a loss function that is based on the Gaussian mixture model.

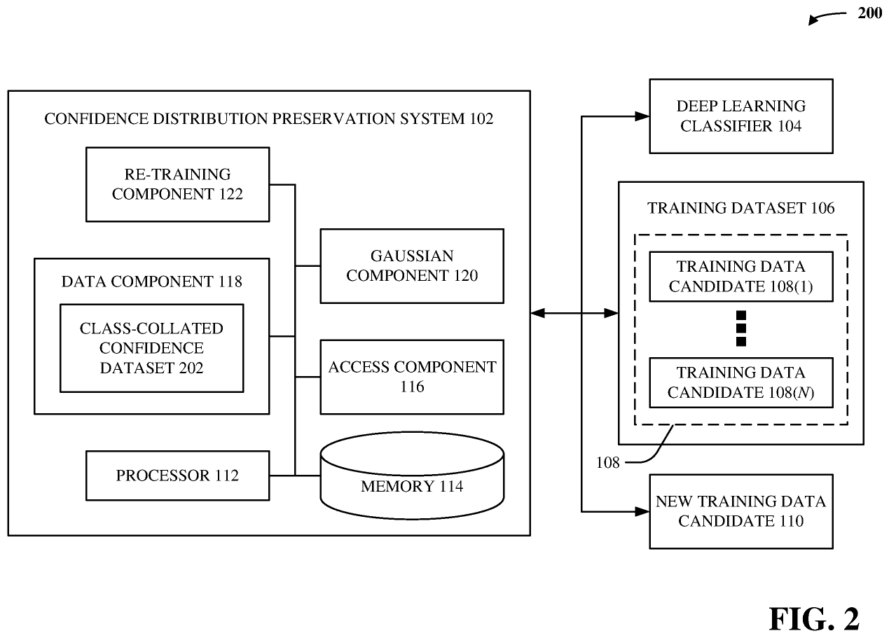

FIG. 2 illustrates a block diagram of an example, non-limiting system 200 including a class-collated confidence dataset that can facilitate preservation of deep learning classifier confidence distributions in accordance with one or more embodiments described herein. As shown, the system 200 can, in some cases, comprise the same components as the system 100, and can further comprise a class-collated confidence dataset 202.

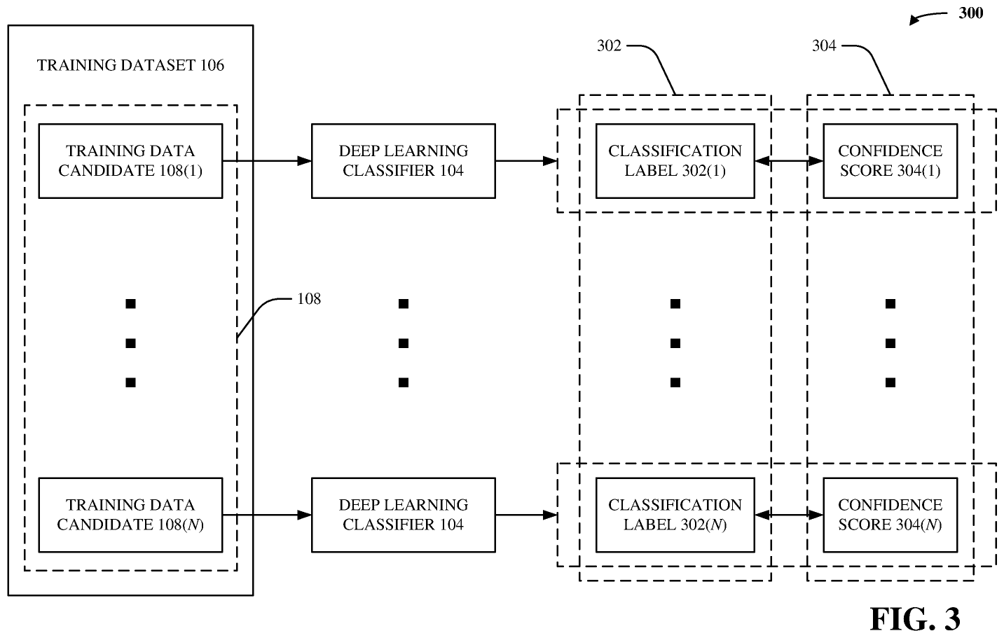

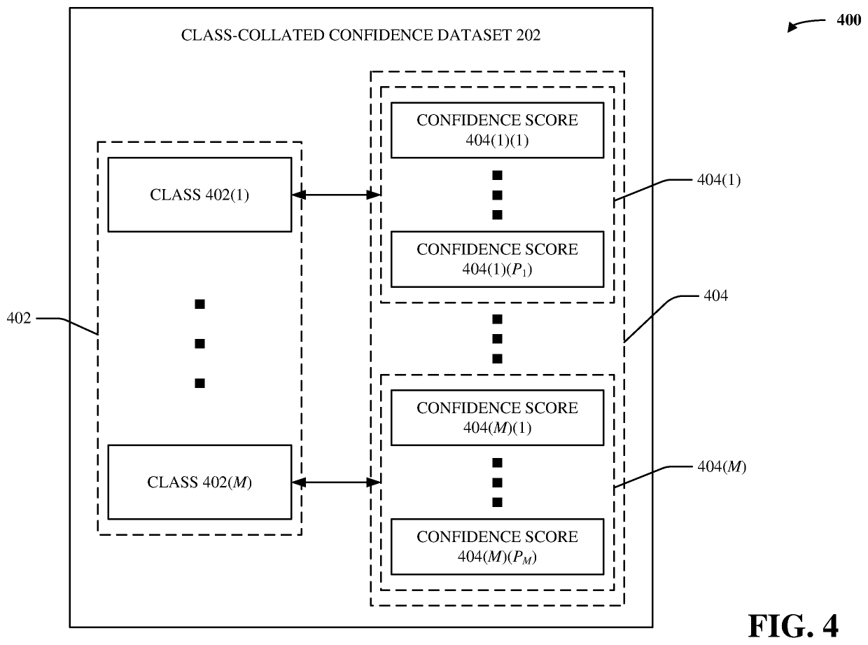

In various aspects, the data component 118 can electronically generate the class-collated confidence dataset 202, based on the training dataset 106 and based on the deep learning classifier 104. More specifically, the data component 118 can execute the deep learning classifier 104 on each of the set of training data candidates 108, thereby yielding a set of label-confidence tuples (e.g., one label-confidence tuple per training data candidate), and the data component 118 can reformat or rearrange such set of label-confidence tuples into the class-collated confidence dataset 202. Various non-limiting aspects are described with respect to FIGS. 3-4.

FIGS. 3-4 illustrate example, non-limiting block diagrams 300 and 400 showing how the class-collated confidence dataset 202 can be generated in accordance with one or more embodiments described herein.

First, consider FIG. 3. As shown, the data component 118 can execute the deep learning classifier 104 on each of the set of training data candidates 108. In various aspects, such executions can yield a set of classification labels 302 and a set of confidence scores 304, both of which can respectively correspond (e.g., in one-to-one fashion) with the set of training data candidates 108.

As a non-limiting example, the data component 118 can execute the deep learning classifier 104 on the training data candidate 108(1), which can cause the deep learning classifier 104 to produce a classification label 302(1) and a confidence score 304(1). More specifically, the data component 118 can feed the training data candidate 108(1) to the input layer of the deep learning classifier 104. In various instances, the training data candidate 108(1) can complete a forward pass through the one or more hidden layers of the deep learning classifier 104, thereby yielding various hidden activation maps or hidden feature maps. In various cases, the output layer of the deep learning classifier 104 can compute both the classification label 302(1) and the confidence score 304(1) based on such hidden activation maps or hidden feature maps. In any case, the classification label 302(1) can be considered as indicating to which one of the m defined classes the deep learning classifier 104 infers or predicts that the training data candidate 108(1) belongs. Moreover, the confidence score 304(1) can be considered as indicating how likely it is that the classification label 302(1) is correct or accurate.

As another non-limiting example, the data component 118 can execute the deep learning classifier 104 on the training data candidate 108(n), which can cause the deep learning classifier 104 to produce a classification label 302(n) and a confidence score 304(n). In particular, the data component 118 can feed the training data candidate 108(n) to the input layer of the deep learning classifier 104. In various aspects, the training data candidate 108(n) can complete a forward pass through the one or more hidden layers of the deep learning classifier 104, thereby yielding various hidden activation maps or hidden feature maps. In various instances, the output layer of the deep learning classifier 104 can compute both the classification label 302(n) and the confidence score 304(n) based on such hidden activation maps or hidden feature maps. In any case, the classification label 302(n) can be considered as indicating to which one of the m defined classes the deep learning classifier 104 infers or predicts that the training data candidate 108(n) belongs. Furthermore, the confidence score 304(n) can be considered as indicating how likely it is that the classification label 302(n) is correct or accurate.

In various aspects, the classification label 302(1) to the classification label 302(n) can collectively be considered as forming the set of classification labels 302. Likewise, in various instances, the confidence score 304(1) to the confidence score 304(n) can collectively be considered as forming the set of confidence scores 304. In various cases, the data component 118 can reformat or rearrange the set of classification labels 302 and the set of confidence scores 304 into the class-collated confidence dataset 202, as shown in FIG. 4.

In particular, as mentioned above, the deep learning classifier 104 can be configured to classify an inputted data candidate into one of m defined classes. In various aspects, such m defined classes can be considered as forming a set of classes 402, where the cardinality of the set of classes 402 can be equal to m. In other words, the set of classes 402 can comprise m classes: a class 402(1) to a class 402(m). In various instances, all of the set of classes 402 can be unique or otherwise distinct from each other.

Now, as also mentioned above, it can be the case that n>m. Accordingly, it can be the case that not all of the set of classification labels 302 are unique or otherwise distinct from each other. In other words, some of the set of classification labels 302 can be considered as indicating or otherwise representing the same defined classes as each other. In still other words, the deep learning classifier 104 can predict or infer that various of the set of training data candidates 108 belong to the same class as each other. In yet other words, the set of classification labels 302 can be considered as respectively corresponding, in non-one-to-one fashion, with the set of classes 402.

As a non-limiting example, suppose that the classification label 302(1) indicates (e.g., corresponds to) the class 402(m). That is, the deep learning classifier 104 can have inferred or predicted that the training data candidate 108(1) belongs to the class 402(m). In some cases, it can be possible that the classification label 302(n) indicates some class other than the class 402(m). In such case, the deep learning classifier 104 can have inferred or predicted that the training data candidate 108(n) belongs to a different class than the training data candidate 108(1). However, in other cases, it can be possible that the classification label 302(n) instead indicates the class 402(m). In such case, the deep learning classifier 104 can have inferred or predicted that the training data candidate 108(n) belongs to the same class as the training data candidate 108(1).

In any case, because the set of classification labels 302 can respectively correspond (albeit not in one-to-one fashion) to the set of classes 402, and because the set of confidence scores 304 can respectively correspond (in one-to-one fashion) with the set of classification labels 302, the set of confidence scores 304 can be considered as respectively corresponding (albeit not in one-to-one fashion) with the set of classes 402.

As a non-limiting example, suppose again that the classification label 302(1) indicates the class 402(m). Thus, the classification label 302(1) can be considered as corresponding to the class 402(m). Furthermore, because the confidence score 304(1) can correspond to the classification label 302(1), the confidence score 304(1) can likewise be considered as corresponding to the class 402(m).

As another non-limiting example, suppose that the classification label 302(n) indicates a class 402(x) (not shown), for any suitable positive integer 1≤x≤m. In such case, the classification label 302(n) can be considered as corresponding to the class 402(x). Moreover, because the confidence score 304(n) can correspond to the classification label 302(n), the confidence score 304(n) can likewise be considered as corresponding to the class 402(x).

In any case, for any given class in the set of classes 402, a respective list of confidence scores from the set of confidence scores 304 can be considered as corresponding to that given class.

As a non-limiting example, the class 402(1) can be considered as corresponding to a confidence score list 404(1). In various aspects, as shown, the confidence score list 404(1) can comprise a total of p₁ confidence scores, for any suitable positive integer p₁<n: a confidence score 404(1)(1) to a confidence score 404(1)(p₁). In various instances, the confidence score list 404(1) can be considered as containing whichever of the set of confidence scores 304 that corresponded to a classification label indicating the class 402(1). That is, the confidence score 404(1)(1) can be a first confidence score from the set of confidence scores 304 whose associated classification label (e.g., a respective one of the set of classification labels 302) indicates the class 402(1). Similarly, the confidence score 404(1)(p₁) can be a p₁-th confidence score from the set of confidence scores 304 whose associated classification label (e.g., a respective one of the set of classification labels 302) indicates the class 402(1).

As another non-limiting example, the class 402(m) can be considered as corresponding to a confidence score list 404(m). In various aspects, as shown, the confidence score list 404(m) can comprise a total of pₘ confidence scores, for any suitable positive integer pₘ<n: a confidence score 404(m)(1) to a confidence score 404(m)(pₘ). In various instances, the confidence score list 404(m) can be considered as containing whichever of the set of confidence scores 304 that corresponded to a classification label indicating the class 402(m). That is, the confidence score 404(m)(1) can be a first confidence score from the set of confidence scores 304 whose associated classification label (e.g., a respective one of the set of classification labels 302) indicates the class 402(m). Likewise, the confidence score 404(m)(pₘ) can be a pₘ-th confidence score from the set of confidence scores 304 whose associated classification label (e.g., a respective one of the set of classification labels 302) indicates the class 402(m).

In various aspects, the confidence score list 404(1) to the confidence score list 404(m) can be collectively considered as forming a set of confidence score lists 404.

Note that, in various instances, it can be the case that Σᵢ₌₁^{m}pᵢ=n. In other words, each of the set of confidence score lists 404 can be considered as a strict subset of the set of confidence scores 304, such that the set of confidence score lists 404 are disjoint (e.g., non-overlapping) with each other.

In various aspects, the class-collated confidence dataset 202 can be considered as comprising the set of classes 402 and the set of confidence score lists 404. Accordingly, the class-collated confidence dataset 202 can be considered as indicating or representing a respective list of confidence scores (e.g., one of 404) for each of the set of classes 402. In various instances, the set of confidence score lists 404 can be considered as being collated according to the set of classes 402 (e.g., as being collated according to unique class), hence the term “class-collated”.

Although not specifically shown in the figures, the data component 118 can, in various embodiments, enlarge or otherwise augment the training dataset 106 (and thus the class-collated confidence dataset 202) by applying any suitable drop-out technique to the training dataset 106. In particular, such drop-out technique can increase the cardinality of the set of training data candidates 108, which can commensurately increase the cardinalities of each of the set of confidence score lists 404.

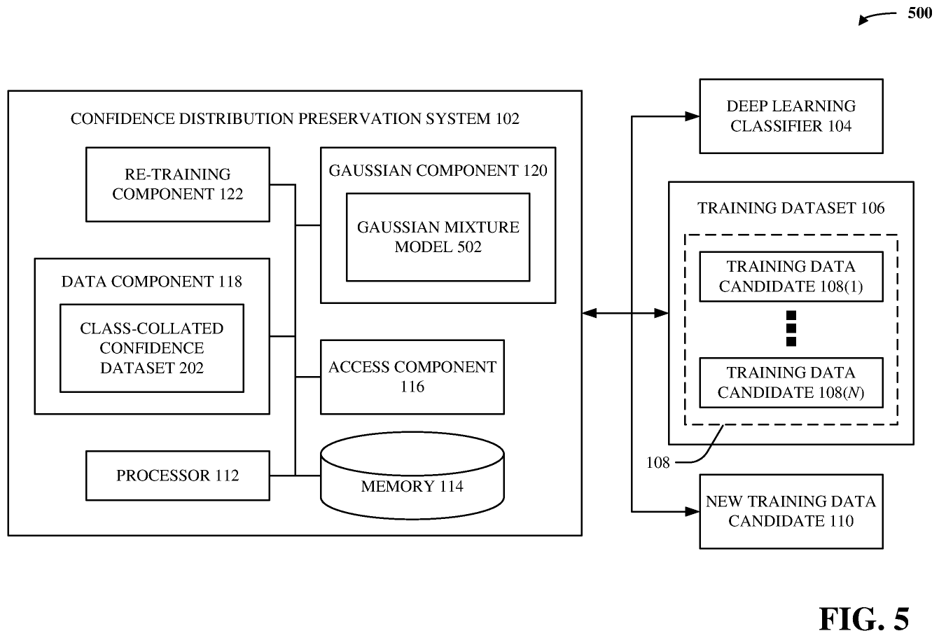

FIG. 5 illustrates a block diagram of an example, non-limiting system 500 including a Gaussian mixture model that can facilitate preservation of deep learning classifier confidence distributions in accordance with one or more embodiments described herein. As shown, the system 500 can, in some cases, comprise the same components as the system 200, and can further comprise a Gaussian mixture model 502.

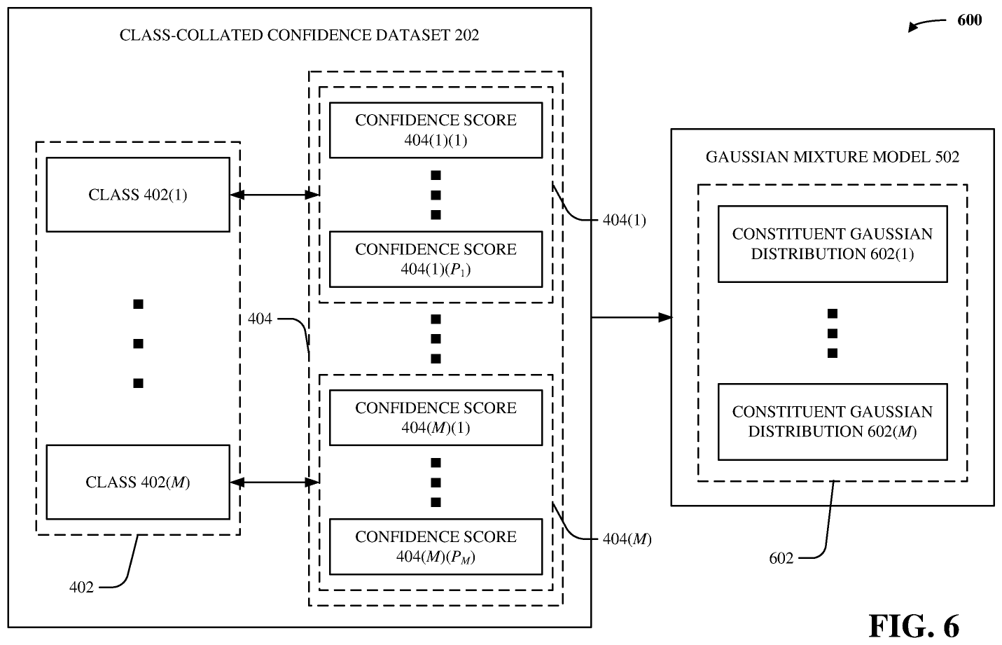

In various embodiments, the Gaussian component 120 can electronically generate the Gaussian mixture model 502, based on the class-collated confidence dataset 202. More specifically, the Gaussian component 120 can fit, in supervised fashion, the Gaussian mixture model 502 to the class-collated confidence dataset 202. Various non-limiting aspects are described with respect to FIG. 6.

FIG. 6 illustrates an example, non-limiting block diagram 600 showing how the Gaussian mixture model 502 can be generated based on the class-collated confidence dataset 202 in accordance with one or more embodiments described herein.

In various aspects, as shown, the Gaussian mixture model 502 can comprise a set of constituent Gaussian distributions 602. In various instances, the set of constituent Gaussian distributions 602 can respectively correspond (e.g., in one-to-one fashion) with the set of classes 402. Accordingly, because the set of classes 402 can include m classes, the set of constituent Gaussian distributions 602 can comprise m constituent Gaussians: a constituent Gaussian distribution 602(1) to a constituent Gaussian distribution 602(m).

In various cases, each of the set of constituent Gaussian distributions 602 can be considered as numerically defining or otherwise representing a distribution of confidence scores associated with a respective one of the set of classes 402. As a non-limiting example, the constituent Gaussian distribution 602(1) can correspond with the class 402(1). Thus, the constituent Gaussian distribution 602(1) can be a bell-curve distribution whose parameters (e.g., mean, variance, standard deviation) can be based on the confidence score list 404(1). That is, the constituent Gaussian distribution 602(1) can be considered as describing how confidence scores generated by the deep learning classifier 104 (after being trained on the training dataset 106) for the class 402(1) are distributed. As another non-limiting example, the constituent Gaussian distribution 602(m) can correspond with the class 402(m). So, the constituent Gaussian distribution 602(m) can be a bell-curve distribution whose parameters (e.g., mean, variance, standard deviation) can be based on the confidence score list 404(m). That is, the constituent Gaussian distribution 602(m) can be considered as describing how confidence scores generated by the deep learning classifier 104 (after being trained on the training dataset 106) for the class 402(m) are distributed. In this way, the Gaussian mixture model 502 can be considered as capturing or otherwise representing class-collated distributions according to which the deep learning classifier 104 was originally trained to produce confidence scores.

Note that the parameters (e.g., means, variances, standard deviations) of each of the set of constituent Gaussian distributions 602 can be initially unknown. Furthermore, note that the set of confidence score lists 404 can be considered as a plurality of already-labeled data points (e.g., already labeled according to the set of classes 402), rather than as a plurality of unlabeled data points. Thus, in various aspects, the parameters of each of the set of constituent Gaussian distributions 602 can be iteratively estimated in supervised fashion (rather than in unsupervised fashion) by fitting the Gaussian mixture model 502 to the class-collated confidence dataset 202. In various instances, any suitable optimization technique can be implemented to facilitate such iterative estimation. As a non-limiting example, expectation maximization can be implemented to fit the Gaussian mixture model 502 to the class-collated confidence dataset 202 in supervised fashion. As another non-limiting example, stochastic gradient descent can be implemented to fit the Gaussian mixture model 502 to the class-collated confidence dataset 202 in supervised fashion.

In any case, each of the set of constituent Gaussian distributions 602 can be considered as not merely being the result of computing the mean, variance, or standard deviation of a respective one of the set of confidence score lists 404. As a non-limiting example, the constituent Gaussian distribution 602(1) can correspond to the class 402(1) and thus to the confidence score list 404(1). However, the mean, variance, or standard deviation of the constituent Gaussian distribution 602(1) can be not merely equal to the mean, variance, or standard deviation of the confidence score list 404(1). Instead, the mean, variance, or standard deviation of the constituent Gaussian distribution 602(1) can be iteratively estimated in supervised fashion based on the confidence score list 404(1) as well as based on the other confidence score lists in the set of confidence score lists 404. As another non-limiting example, the constituent Gaussian distribution 602(m) can correspond to the class 402(m) and thus to the confidence score list 404(m). However, the mean, variance, or standard deviation of the constituent Gaussian distribution 602(m) can be not merely equal to the mean, variance, or standard deviation of the confidence score list 404(m). Instead, the mean, variance, or standard deviation of the constituent Gaussian distribution 602(m) can be iteratively estimated in supervised fashion based on the confidence score list 404(m) as well as based on the other confidence score lists in the set of confidence score lists 404.

Accordingly, the Gaussian mixture model 502 can be considered as representing or describing the distributions according to which the deep learning classifier 104 was originally trained to produce confidence scores. Any confidence threshold value that has been experimentally obtained for the deep learning classifier 104 can be considered as being tailored to the distributions represented by the Gaussian mixture model 502.

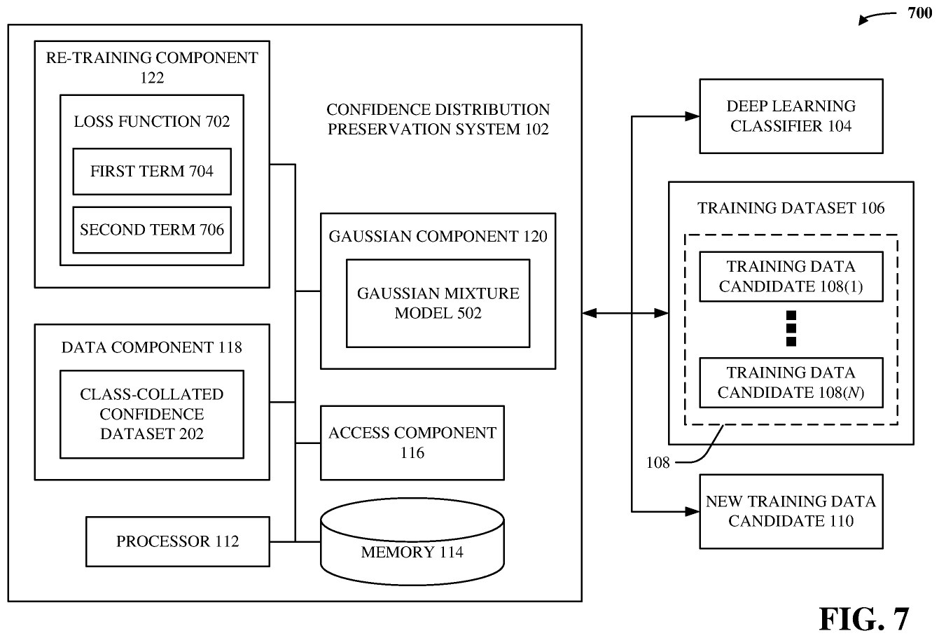

FIG. 7 illustrates a block diagram of an example, non-limiting system 700 including a loss function that can facilitate preservation of deep learning classifier confidence distributions in accordance with one or more embodiments described herein. As shown, the system 700 can, in some cases, comprise the same components as the system 500, and can further comprise a loss function 702.

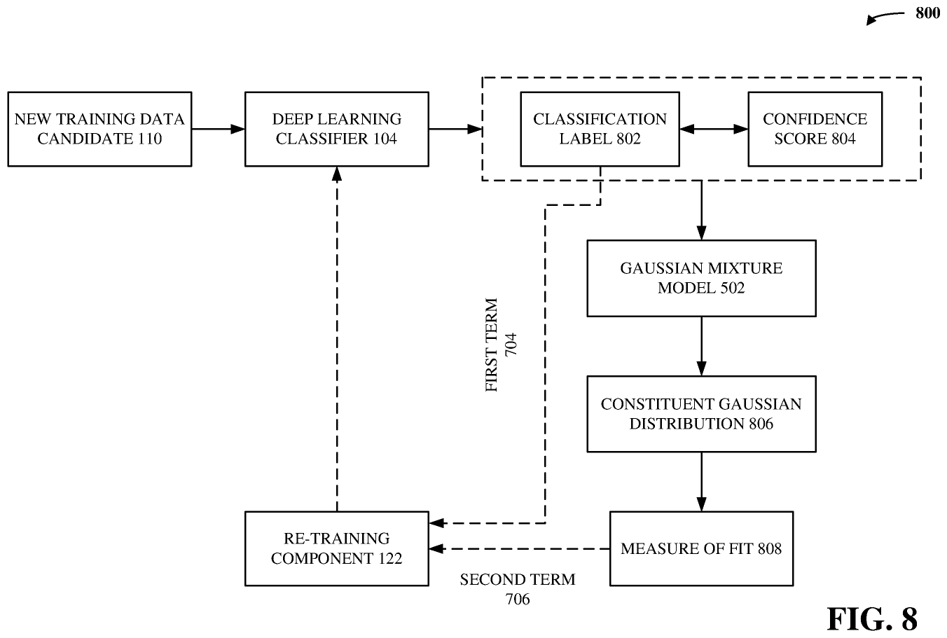

In various embodiments, the re-training component 122 can electronically re-train the deep learning classifier 104 on the new training data candidate 110 using the loss function 702, where the loss function 702 can be based on the Gaussian mixture model 502. More specifically, the loss function 702 can comprise a first term 704 and a second term 706. In various aspects, the loss function 702 can be equal to or otherwise based on any suitable mathematical combination of the first term 704 and the second term 706. As a non-limiting example, the loss function 702 can be equal to any suitable weighted or non-weighted linear combination of the first term 704 and the second term 706. As another non-limiting example, the loss function 702 can be equal to any suitable weighted or non-weighted non-linear combination of the first term 704 and the second term 706. In any case, the first term 704 can be any suitable numerical error or numerical loss that quantifies how accurately or how inaccurately the deep learning classifier 104 is able to generate classification labels. As a non-limiting example, the first term 704 can be whatever error or loss was implemented to train the deep learning classifier 104 on the training dataset 106. In contrast, the second term 706 can be any suitable numerical error or numerical loss that quantifies how well or how poorly the deep learning classifier 104 is able to follow the Gaussian mixture model 502 when generating confidence scores. Non-limiting aspects are described with respect to FIG. 8.

FIG. 8 illustrates an example, non-limiting block diagram 800 showing how the deep learning classifier 104 can be re-trained based on the Gaussian mixture model 502 in accordance with one or more embodiments described herein.

In various embodiments, the re-training component 122 can execute the deep learning classifier 104 on the new training data candidate 110. In various aspects, such execution can cause the deep learning classifier 104 to produce as output a classification label 802 and a confidence score 804. More specifically, the re-training component 122 can feed the new training data candidate 110 to the input layer of the deep learning classifier 104. In various instances, the new training data candidate 110 can complete a forward pass through the one or more hidden layers of the deep learning classifier 104, thereby yielding various hidden activation maps or hidden feature maps. In various cases, the output layer of the deep learning classifier 104 can compute both the classification label 802 and the confidence score 804 based on such hidden activation maps or hidden feature maps. In any case, the classification label 802 can be considered as indicating to which one of the m defined classes the deep learning classifier 104 infers or predicts that the new training data candidate 110 belongs. Note that the classification label 802 can be incorrect or inaccurate. Furthermore, the confidence score 804 can be considered as indicating how likely it is that the classification label 802 is correct or accurate.

In various aspects, the re-training component 122 can compute the first term 704 based on the classification label 802. As a non-limiting example, suppose that the new training data candidate 110 is annotated. In such case, the new training data candidate 110 can be considered as corresponding to a ground-truth annotation (not shown), where such ground-truth annotation can be considered as the correct or accurate classification label that is known or otherwise deemed to correspond to the new training data candidate 110. Accordingly, the first term 704 can be equal to or otherwise based on any suitable error (e.g., MAE, MSE, cross-entropy) between the classification label 802 and that ground-truth annotation. As another non-limiting example, suppose that the new training data candidate 110 is instead unannotated. In such case, the first term 704 can be equal to or otherwise based on any suitable unsupervised error or reinforcement learning error that is a function of the classification label 802.

In various instances, the re-training component 122 can identify, within the Gaussian mixture model 502, a constituent Gaussian distribution 806 based on the classification label 802. More specifically, the classification label 802 can be considered as indicating a particular class from the set of classes 402. In various cases, the constituent Gaussian distribution 806 can be whichever of the set of constituent Gaussian distributions 602 corresponds to that particular class.

In various aspects, the re-training component 122 can compute a measure of fit 808 between the constituent Gaussian distribution 806 and the confidence score 804. In various instances, the measure of fit 808 can be any suitable real-valued scalar whose magnitude indicates how well or how poorly the confidence score 804 fits into the constituent Gaussian distribution 806. As a non-limiting example, the measure of fit 808 can be equal to or otherwise based on an integration degree computed between the constituent Gaussian distribution 806 and the confidence score 804. As another non-limiting example, the measure of fit 808 can be equal to or otherwise based on how many standard deviations separate the confidence score 804 from a mean of the constituent Gaussian distribution 806. As even another non-limiting example, the measure of fit 808 can be equal to or otherwise based on a probability or likelihood that the confidence score 804 came from the constituent Gaussian distribution 806. In some cases, a higher magnitude of the measure of fit 808 can indicate better fit between the confidence score 804 and the constituent Gaussian distribution 806, and a lower magnitude of the measure of fit 808 can indicate worse fit between the confidence score 804 and the constituent Gaussian distribution 806. However, in other cases, a lower magnitude of the measure of fit 808 can indicate better fit between the confidence score 804 and the constituent Gaussian distribution 806, and a higher magnitude of the measure of fit 808 can indicate worse fit between the confidence score 804 and the constituent Gaussian distribution 806.

In various aspects, the re-training component 122 can compute the second term 706 based on the measure of fit 808. As a non-limiting example, the second term 706 can be equal to or otherwise based on any suitable mathematical function that can take as an argument the measure of fit 808, such that the second term 706 increases in magnitude as the measure of fit 808 worsens (e.g., as the measure of fit 808 indicates worse fit between the confidence score 804 and the constituent Gaussian distribution 806), and such that the second term 706 decreases in magnitude as the measure of fit 808 improves (e.g., as the measure of fit 808 indicates better fit between the confidence score 804 and the constituent Gaussian distribution 806).

In any case, the re-training component 122 can compute the loss function 702 based on the first term 704 and the second term 706. Accordingly, the re-training component 122 can incrementally update, via backpropagation (e.g., stochastic gradient descent), the trainable internal parameters (e.g., convolutional kernels, weight matrices, bias values) of the deep learning classifier 104, where such backpropagation can be driven by the loss function 702.

Although the herein disclosure mainly describes the re-training component 122 as re-training the deep learning classifier 104 based on one new training data candidate (e.g., 110), this is a mere non-limiting example for ease of explanation and illustration. In various aspects, any suitable number of new training data candidates can be implemented for re-training of the deep learning classifier 104. Indeed, any suitable training batch sizes can be implemented by the re-training component 122, and any suitable re-training termination criterion can be implemented by the re-training component 122.

Note that the first term 704 can, when iterated over multiple epochs, be considered as forcing or otherwise causing the deep learning classifier 104 to learn how to accurately classify new training data candidates. In contrast, note that the second term 706 can, when iterated over multiple epochs, be considered as forcing or otherwise causing the deep learning classifier 104 to produce confidence scores according to the class-collated distributions represented by the Gaussian mixture model 502. Thus, when the deep learning classifier 104 is re-trained as described herein, the deep learning classifier 104 can learn how to handle new data candidates while nevertheless producing confidence scores according to its original confidence score distributions. In other words, various embodiments described herein can be considered as having prevented re-training from substantially altering or destabilizing the class-collated distributions according to which the deep learning classifier 104 generates confidence scores. Thus, any confidence threshold value that was previously experimentally obtained for the deep learning classifier 104 need not be experimentally re-obtained after re-training, which can be considered as saving time or other resources.

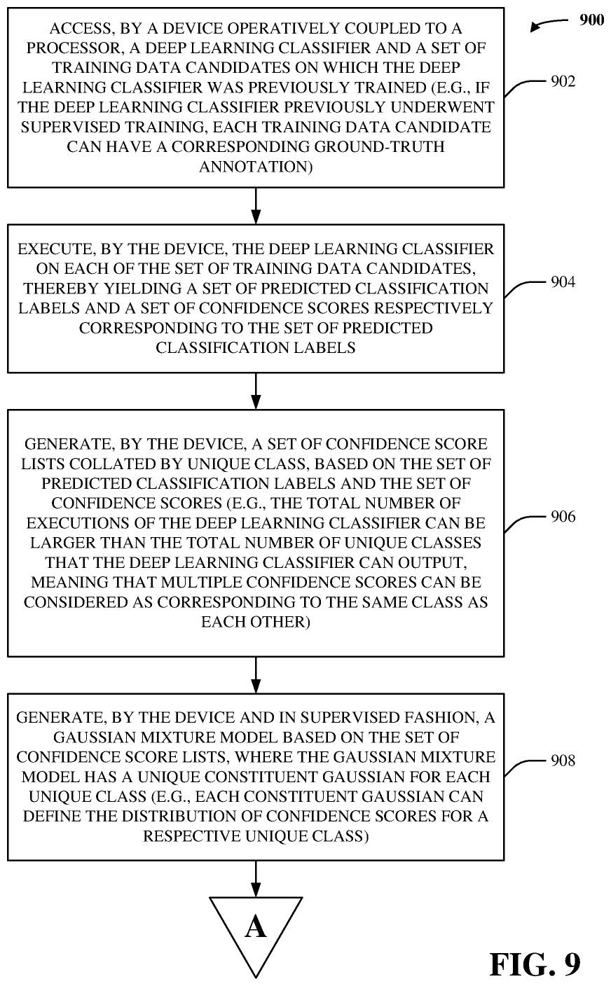

FIGS. 9-11 illustrate flow diagrams of example, non-limiting computer-implemented methods 900, 1000, and 1100 that can facilitate preservation of deep learning classifier confidence distributions in accordance with one or more embodiments described herein. In various cases, the confidence distribution preservation system 102 can facilitate the computer-implemented methods 900, 1000, or 1100.

First, consider FIG. 9. In various embodiments, act 902 can include accessing, by a device (e.g., via 116) operatively coupled to a processor (e.g., 112), a deep learning classifier (e.g., 104) and a set of training data candidates (e.g., 108) on which the deep learning classifier was previously trained. In various cases, if the deep learning classifier previously underwent supervised training, each of the set of training data candidates can have a corresponding to ground-truth annotation.

In various aspects, act 904 can include executing, by the device (e.g., via 118), the deep learning classifier on each of the set of training data candidates. In various cases, this can yield a set of predicted classification labels (e.g., 302) and a set of confidence scores (e.g., 304) respectively corresponding to the set of predicted classification labels.

In various instances, act 906 can include generating, by the device (e.g., via 118), a set of confidence score lists (e.g., 404) collated by unique class (e.g., collated by 402), based on the set of predicted classification labels and the set of confidence scores. In various cases, the total number (e.g., n) of executions of the deep learning classifier during act 906 can be larger than the total number (e.g., m) of unique classes that the deep learning classifier can output. Thus, multiple confidence scores can be considered as corresponding to the same class as each other. In other words, each class can have an associated list of confidence scores.

In various aspects, act 908 can include generating, by the device (e.g., via 120) and in supervised fashion, a Gaussian mixture model (e.g., 502) based on the set of confidence score lists. In various cases, the Gaussian mixture model can have a unique constituent Gaussian (e.g., one of 602) for each unique class. In other words, each constituent Gaussian can define the distribution of confidence scores for a respective unique class.

As shown, the computer-implemented method 900 can proceed to act 1002 of the computer-implemented method 1000.

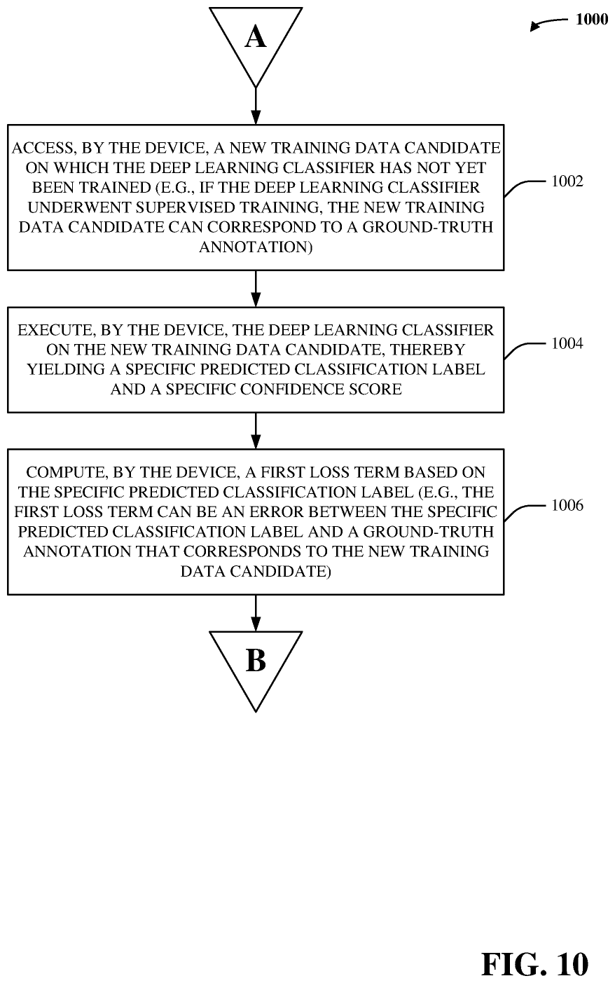

Now, consider FIG. 10. In various embodiments, act 1002 can include accessing, by the device (e.g., via 116), a new training data candidate (e.g., 110) on which the deep learning classifier has not yet been trained. In various cases, if the deep learning classifier previously underwent supervised training, the new training data candidate can correspond to a ground-truth annotation.

In various aspects, act 1004 can include executing, by the device (e.g., via 122), the deep learning classifier on the new training data candidate. This can yield a specific predicted classification label (e.g., 802) and a specific confidence score (e.g., 804).

In various instances, act 1006 can include computing, by the device (e.g., via 122), a first loss term (e.g., 704) based on the specific predicted classification label. For example, the first loss term can be an error (e.g., MAE, MSE, cross-entropy) between the specific predicted classification label and a ground-truth annotation corresponding to the new training data candidate.

As shown, the computer-implemented method 1000 can proceed to act 1102 of the computer-implemented method 1100.

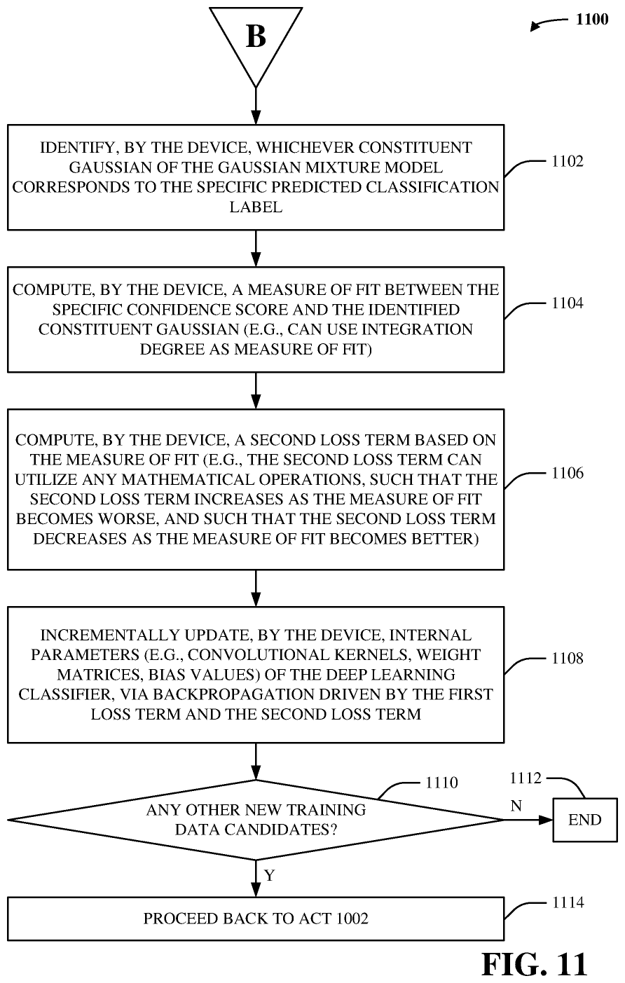

Now, consider FIG. 11. In various embodiments, act 1102 can include identifying, by the device (e.g., via 122), whichever constituent Gaussian (e.g., 806) of the Gaussian mixture model corresponds to the specific predicted classification label.

In various aspects, act 1104 can include computing, by the device (e.g., via 122), a measure of fit (e.g., 808) between the specific confidence score and the identified constituent Gaussian. In various cases, the measure of fit can be equal to integration degree or distance from mean.

In various instances, act 1106 can include computing, by the device (e.g., via 122), a second loss term (e.g., 706) based on the measure of fit. In various cases, the second loss term can utilize any suitable mathematical operations, such that the second loss term increases as the measure of fit becomes worse, and such that the second loss term decreases as the measure of fit becomes better.

In various aspects, act 1108 can include incrementally updating, by the device (e.g., via 122), internal parameters (e.g., convolutional kernels, weight matrices, bias values) of the deep learning classifier, via backpropagation driven by the first loss term and by the second loss term.

In various instances, act 1110 can include determining, by the device (e.g., via 122), whether any other new training data candidates are available that have not yet been used to train the deep learning classifier. If not, the computer-implemented method 1100 can end at act 1112. If so, the computer-implemented method 1100 can instead proceed back to act 1002, as shown by numeral 1114.

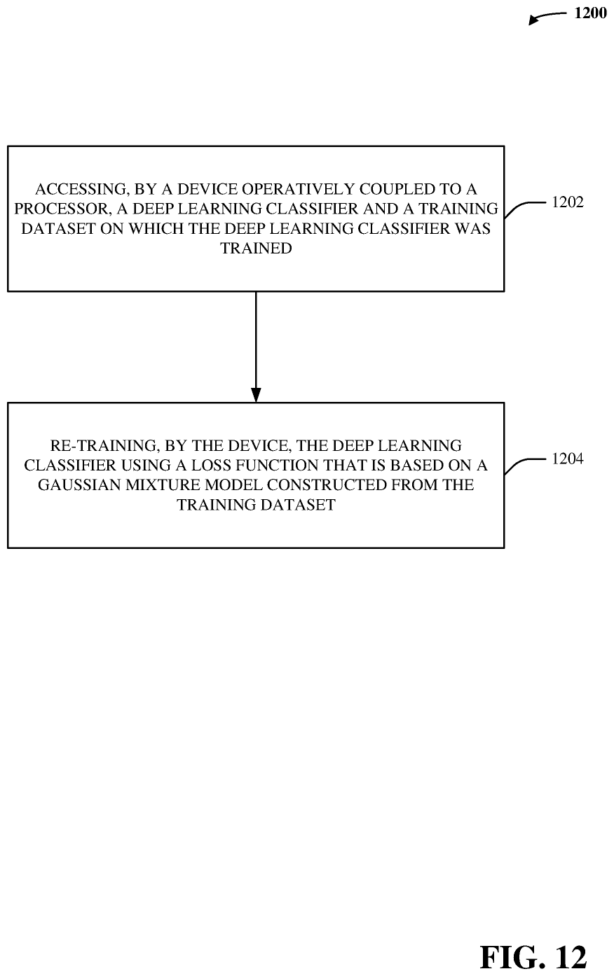

FIG. 12 illustrates a flow diagram of an example, non-limiting computer-implemented method 1200 that can facilitate preservation of deep learning classifier confidence distributions in accordance with one or more embodiments described herein. In various cases, the confidence distribution preservation system 102 can facilitate the computer-implemented method 1200.

In various embodiments, act 1202 can include accessing, by a device (e.g., via 116) operatively coupled to a processor (e.g., 112), a deep learning classifier (e.g., 104) and a training dataset (e.g., 106) on which the deep learning classifier was trained.

In various aspects, act 1204 can include re-training, by the device (e.g., via 122), the deep learning classifier using a loss function (e.g., 702) that is based on a Gaussian mixture model (e.g., 502) constructed from the training dataset.

Although not explicitly shown in FIG. 12, the deep learning classifier can be configured to receive a data candidate as input and to produce a classification label and a confidence score as output, and the computer-implemented method 1200 can comprise: generating, by the device (e.g., via 118), a set of confidence lists (e.g., 404) collated according to class (e.g., 402), by executing the deep learning classifier on the training dataset (e.g., as shown with respect to FIGS. 3-4).

Although not explicitly shown in FIG. 12, the computer-implemented method 1200 can comprise: generating, by the device (e.g., via 120), the Gaussian mixture model based on the set of confidence lists, wherein constituent Gaussian distributions (e.g., 602) of the Gaussian mixture model respectively correspond to unique classes (e.g., 402).

Although not explicitly shown in FIG. 12, the computer-implemented method 1200 can comprise: accessing, by the device (e.g., via 116), a training data candidate (e.g., 110) on which the deep learning classifier has not been trained; and executing, by the device (e.g., via 122), the deep learning classifier on the training data candidate, thereby yielding a first classification label (e.g., 802) and a first confidence score (e.g., 804).

Although not explicitly shown in FIG. 12, the first classification label can correspond to a first constituent Gaussian distribution (e.g., 806) of the Gaussian mixture model, and the computer-implemented method 1200 can comprise: determining, by the device (e.g., via 122) and via the Gaussian mixture model, a measure of fit (e.g., 808) between the first confidence score and the first constituent Gaussian distribution.

Although not explicitly shown in FIG. 12, the loss function can comprise a first term (e.g., 704) that is based on the first classification label, and the loss function can comprise a second term (e.g., 706) that is based on the measure of fit.

Although not explicitly shown in FIG. 12, the computer-implemented method 1200 can comprise: generating, by the device (e.g., via 118), the set of confidence lists based on applying a drop out technique to the training dataset.

Accordingly, various embodiments described herein can be considered as facilitating re-training of a deep learning classifier without upsetting or substantially changing the distributions according to which the deep learning classifier produces confidence scores. Thus, confidence threshold values need not be experimentally re-determined after each epoch or wave of re-training, in stark contrast to existing techniques. For at least these reasons, various embodiments described herein certainly constitute useful and practical applications of computers.

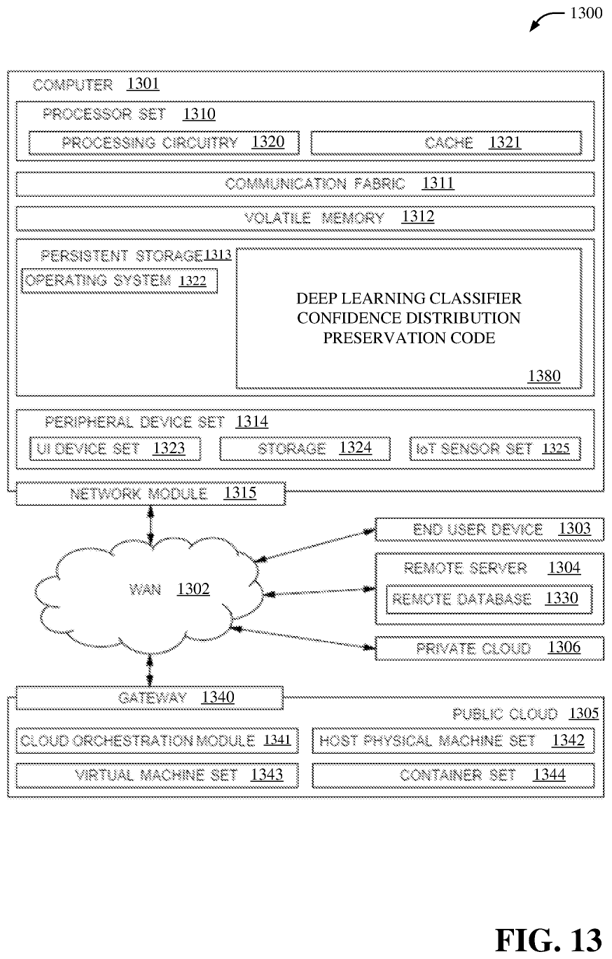

FIG. 13 and the following discussion are intended to provide a brief, general description of a suitable computing environment 1300 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as deep learning classifier confidence distribution preservation code 1380. In addition to block 1380, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1380, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method can be distributed among multiple computers or between multiple locations. On the other hand, in this presentation of computing environment 1300, detailed discussion is focused on a single computer, specifically computer 1301, to keep the presentation as simple as possible. Computer 1301 can be located in a cloud, even though it is not shown in a cloud in FIG. 13. On the other hand, computer 1301 is not required to be in a cloud except to any extent as can be affirmatively indicated.

PROCESSOR SET 1310 includes one, or more, computer processors of any type now known or to be developed in the future. Processing circuitry 1320 can be distributed over multiple packages, for example, multiple, coordinated integrated circuit chips. Processing circuitry 1320 can implement multiple processor threads or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set can be located “off chip.” In some computing environments, processor set 1310 can be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods can be stored in block 1380 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory can be distributed over multiple packages or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 or directly to persistent storage 1313. Persistent storage 1313 can be a read only memory (ROM), but typically at least a portion of the persistent storage allows writing of data, deletion of data and re-writing of data. Some familiar forms of persistent storage include magnetic disks and solid-state storage devices. Operating system 1322 can take several forms, such as various known proprietary operating systems or open-source Portable Operating System Interface type operating systems that employ a kernel. The code included in block 1380 typically includes at least some of the computer code involved in performing the inventive methods.

PERIPHERAL DEVICE SET 1314 includes the set of peripheral devices of computer 1301. Data communication connections between the peripheral devices and the other components of computer 1301 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 can include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 can be persistent or volatile. In some embodiments, storage 1324 can take the form of a quantum computing storage device for storing data in the form of qubits. In embodiments where computer 1301 is required to have a large amount of storage (for example, where computer 1301 locally stores and manages a large database) then this storage can be provided by peripheral storage devices designed for storing large amounts of data, such as a storage area network (SAN) that is shared by multiple, geographically distributed computers. IoT sensor set 1325 is made up of sensors that can be used in Internet of Things applications. For example, one sensor can be a thermometer and another sensor can be a motion detector.

NETWORK MODULE 1315 is the collection of computer software, hardware, and firmware that allows computer 1301 to communicate with other computers through WAN 1302. Network module 1315 can include hardware, such as modems or Wi-Fi signal transceivers, software for packetizing or de-packetizing data for communication network transmission, or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301) and can take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 can be a client device, such as thin client, heavy client, mainframe computer or desktop computer.

REMOTE SERVER 1304 is any computer system that serves at least some data or functionality to computer 1301. Remote server 1304 can be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data can be provided to computer 1301 from remote database 1330 of remote server 1304.

PUBLIC CLOUD 1305 is any computer system available for use by multiple entities that provides on-demand availability of computer system resources or other computer capabilities, especially data storage (cloud storage) and computing power, without direct active management by the scale. The direct and active management of the computing resources of public cloud 1305 is performed by the computer hardware or software of cloud orchestration module 1341. The computing resources provided by public cloud 1305 are typically implemented by virtual computing environments that run on various computers making up the computers of host physical machine set 1342, which is the universe of physical computers in or available to public cloud 1305. The virtual computing environments (VCEs) typically take the form of virtual machines from virtual machine set 1343 or containers from container set 1344. It is understood that these VCEs can be stored as images and can be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware and firmware allowing public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1305 and private cloud 1306 are both part of a larger hybrid cloud.

The herein disclosure describes non-limiting examples of various embodiments of the subject innovation. For ease of description or explanation, various portions of the herein disclosure utilize the term “each” when discussing various embodiments of the subject innovation. Such usages of the term “each” are non-limiting examples. In other words, when the herein disclosure provides a description that is applied to “each” of some particular object or component, it should be understood that this is a non-limiting example of various embodiments of the subject innovation, and it should be further understood that, in various other embodiments of the subject innovation, it can be the case that such description applies to fewer than “each” of that particular object or component.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable components stored in a non-transitory computer-readable memory, wherein the computer-executable components comprise:
an access component that accesses a deep learning classifier and a training dataset on which the deep learning classifier was trained; and
a re-training component that re-trains the deep learning classifier using a loss function that is based on a Gaussian mixture model constructed from the training dataset.

2. The system of claim 1, wherein the deep learning classifier is configured to receive a data candidate as input and to produce a classification label and a confidence score as output, and wherein the computer-executable components further comprise:
a data component that generates a set of confidence lists collated according to class, by executing the deep learning classifier on the training dataset.

3. The system of claim 2, wherein the computer-executable components further comprise:
a Gaussian component that generates the Gaussian mixture model based on the set of confidence lists, wherein constituent Gaussian distributions of the Gaussian mixture model respectively correspond to unique classes.

4. The system of claim 3, wherein the access component accesses a training data candidate on which the deep learning classifier has not been trained, and wherein the re-training component executes the deep learning classifier on the training data candidate, thereby yielding a first classification label and a first confidence score.

5. The system of claim 4, wherein the first classification label corresponds to a first constituent Gaussian distribution of the Gaussian mixture model, and wherein the re-training component determines, via the Gaussian mixture model, a measure of fit between the first confidence score and the first constituent Gaussian distribution.

6. The system of claim 5, wherein the loss function comprises a first term that is based on the first classification label, and wherein the loss function comprises a second term that is based on the measure of fit.

7. The system of claim 2, wherein the data component generates the set of confidence lists based on applying a drop out technique to the training dataset.

8. A computer-implemented method, comprising:
accessing, by a device operatively coupled to a processor, a deep learning classifier and a training dataset on which the deep learning classifier was trained; and
re-training, by the device, the deep learning classifier using a loss function that is based on a Gaussian mixture model constructed from the training dataset.

9. The computer-implemented method of claim 8, wherein the deep learning classifier is configured to receive a data candidate as input and to produce a classification label and a confidence score as output, and further comprising:
generating, by the device, a set of confidence lists collated according to class, by executing the deep learning classifier on the training dataset.

10. The computer-implemented method of claim 9, further comprising:
generating, by the device, the Gaussian mixture model based on the set of confidence lists, wherein constituent Gaussian distributions of the Gaussian mixture model respectively correspond to unique classes.

11. The computer-implemented method of claim 10, further comprising:
accessing, by the device, a training data candidate on which the deep learning classifier has not been trained; and
executing, by the device, the deep learning classifier on the training data candidate, thereby yielding a first classification label and a first confidence score.

12. The computer-implemented method of claim 11, wherein the first classification label corresponds to a first constituent Gaussian distribution of the Gaussian mixture model, and further comprising:
determining, by the device and via the Gaussian mixture model, a measure of fit between the first confidence score and the first constituent Gaussian distribution.

13. The computer-implemented method of claim 12, wherein the loss function comprises a first term that is based on the first classification label, and wherein the loss function comprises a second term that is based on the measure of fit.

14. The computer-implemented method of claim 9, further comprising:
generating, by the device, the set of confidence lists based on applying a drop out technique to the training dataset.

15. A computer program product for facilitating preservation of deep learning classifier confidence distributions, the computer program product comprising a non-transitory computer-readable memory having program instructions embodied therewith, the program instructions executable by a processor to cause the processor to:
access a deep learning classifier and a training dataset on which the deep learning classifier was trained; and
re-train the deep learning classifier using a loss function that is based on a Gaussian mixture model constructed from the training dataset.

16. The computer program product of claim 15, wherein the deep learning classifier is configured to receive a data candidate as input and to produce a classification label and a confidence score as output, and wherein the program instructions are further executable to cause the processor to:
generate a set of confidence lists collated according to class, by executing the deep learning classifier on the training dataset.

17. The computer program product of claim 16, wherein the program instructions are further executable to cause the processor to:
generate the Gaussian mixture model based on the set of confidence lists, wherein constituent Gaussian distributions of the Gaussian mixture model respectively correspond to unique classes.

18. The computer program product of claim 17, wherein the program instructions are further executable to cause the processor to:
access a training data candidate on which the deep learning classifier has not been trained; and
execute the deep learning classifier on the training data candidate, thereby yielding a first classification label and a first confidence score.

19. The computer program product of claim 18, wherein the first classification label corresponds to a first constituent Gaussian distribution of the Gaussian mixture model, and wherein the program instructions are further executable to cause the processor to:
determine, via the Gaussian mixture model, a measure of fit between the first confidence score and the first constituent Gaussian distribution.

20. The computer program product of claim 19, wherein the loss function comprises a first term that is based on the first classification label, and wherein the loss function comprises a second term that is based on the measure of fit.
